(19) United States
(12) Patent Application Publication
(10) Pub. No.: US 2016/0034951 A1
(43) Pub. Date: Feb. 4, 2016

(54) ALLOCATING PROMINENT DISPLAY SPACE FOR QUERY ANSWERS

(71) Applicant: Microsoft Corporation, Redmond, WA (US)

(72) Inventors: SALVADOR CELIS, Seattle, WA (US); PANKESH JHAVERI, Bellevue, WA (US); HRISHIKESH BAL, Bellevue, WA (US)

(21) Appl. No.: 14/447,365

(22) Filed: Jul. 30, 2014

(51) Int. Cl. G06Q 30/02; G06F 17/30

(52) U.S. Cl. CPC G06Q 30/0251; G06F 17/30864; G06F 17/30554

(57) ABSTRACT

Systems, methods, and computer-readable storage media are provided for allocating prominent display space for relevant answers to search queries. Upon receipt of a search query, an intent associated with the search query is determined. That is, it is determined what question the search query states or implies is on the mind of the search query originator. Once the intent is determined, an answer to the search query is determined, for instance, by reference to one or more of search query history logs, search engine click metrics, user history (specific and/or aggregate), and search query categories. The answer is then paired with a sponsor and prominent display space is allocated. The answer and indicia associated with the sponsor are caused to be presented in association with one another in the prominent display space on a search engine results page.

### BACKGROUND

Multiple online search engines exist today that permit users to search multiple sources of content on the World Wide Web from a common interface. Users typically input a search query comprised of one or more words or symbols into a designated search input region and the search engine utilizes the input search query to conduct a search of web content sources in an attempt to return relevant information to the user. Often when users are conducting a search utilizing an online search engine, for instance, the BING search engine provided by Microsoft Corporation of Redmond, Washington, the query originator has a specific question on his or her mind that s/he would like answered. For instance, a user may wish to know what time a particular flight is landing at a local airport, what computer is the best for a college student and/or where to buy such computer, or what there is to do in a tourist location such as San Francisco.

Generally, advertisements are presented in association with search results pages based upon query terms that advertisers have bid upon or otherwise purchased. Accordingly, while the ads displayed may have relevance to one or more query terms, they are often not necessarily relevant to the question that the query originator may have had in mind upon entering the query.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for allocating prominent display space for relevant answers to search queries. Upon receipt of a search query (e.g., via a search engine or the like), an intent associated with the search query is determined. That is, it is determined what question the search query states or implies is on the mind of the search query originator. Once the intent is determined, an answer to the search query is determined, for instance, by reference to one or more of search query history logs, search engine click metrics, user history, and search query categories. The answer is then paired with a sponsor (for instance, an advertiser) and prominent display space for the relevant answer is allocated. The relevant answer and indicia associated with the sponsor (e.g., a logo) are caused to be presented in association with one another in the allocated prominent display space on a Search Engine Results Page (SERP).

Embodiments of the present invention provide a likely answer to the intent behind an input search query. Because the answer is paired with a sponsor having relevance to the intent and/or the search query, an opportunity is provided for the sponsor to have a meaningful and direct interaction with the search query originator. Additionally, because relevant answers to a query originator's question or intent are prominently arranged on the SERP, user interaction performance is more efficient and enhanced.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a schematic diagram showing an exemplary screen shot illustrating presentation in a prominent display space of a sponsored answer to the search query “best laptops for students,” in accordance with an embodiment of the present invention;

FIG. 4 is a schematic diagram showing an exemplary screen shot illustrating presentation in a prominent display space of a sponsored answer to the search query “pancake recipe,” in accordance with an embodiment of the present invention;

FIG. 5 is a schematic diagram showing an exemplary screen shot illustrating presentation in a prominent display space of a sponsored answer to the search query “San Francisco,” in accordance with an embodiment of the present invention;

FIG. 6 is a schematic diagram showing an exemplary screen shot illustrating presentation in a prominent display space of a sponsored answer to the search query “when is superbowl 2013,” in accordance with an embodiment of the present invention;

FIG. 7 is a flow diagram showing an exemplary method for allocating prominent display space for relevant answers to search queries, in accordance with an embodiment of the present invention; and

FIG. 8 is a flow diagram showing another exemplary method for allocating prominent display space for relevant answers to search queries, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for allocating prominent display space for relevant answers to search queries. Oftentimes, when persons are conducting a search (for instance, utilizing an Internet search engine), they are searching for an answer to a question they have on their mind. To address the “question” or intent associated with a search query, upon receipt of the search query (e.g., via a search engine or the like), an intent associated with the search engine is determined. That is, it is determined what “question” the search query states or implies is on the mind of the search query originator. Once the intent is determined, a relevant answer to the search query is determined. Such determination may be made, by way of example only, by reference to one or more of search query history logs, search engine click metrics, user history, and search query categories. The relevant answer is then paired with a sponsor or advertiser from which a portion of the answer content may or may not have been derived and prominent display space for the relevant answer is allocated. The answer and indicia associated with the sponsor (e.g., a logo) are caused to be presented in association with one another in the prominent display space on a Search Engine Results Page (SERP). Generally, the prominent display space is associated with a portion of the SERP that is distinct from a display space allocated for providing links to results of the search query determined based upon keyword matching and the like.

Embodiments of the present invention provide a likely answer to the intent behind an input search query. Because the answer is paired with a sponsor having relevance to the intent and/or the search query, an opportunity is provided for the sponsor to have a meaningful and direct interaction with the search query originator. Additionally, because relevant answers to a query originator's question or intent are prominently arranged on the SERP, user interaction performance is more efficient. That is, due to the prominent placement of relevant query answers, users are able to more efficiently and directly receive and interact with answers to search queries and/or intents behind search queries providing an enhanced search experience.

Accordingly, one embodiment of the present invention is directed to one or more computer-readable storage media storing computer-useable instructions that, when used by one or more computing devices, cause the one or more computing devices to perform a method for allocating prominent display space for relevant answers to search queries. The method includes receiving a search query; determining a relevant answer to the received search query; allocating prominent display space for the relevant answer to the search query, the relevant answer being paired with a sponsor; and causing presentation of the answer and indicia associated with the sponsor in association with one another in the prominent display space on a SERP.

In another embodiment, the present invention is directed to a method being performed by one or more computing devices including at least one processor, the method for allocating prominent display space for relevant answers to search queries. The method includes receiving a search query having at least one of an explicit intent or an implicit intent; determining a relevant answer to the explicit and/or the implicit intent; allocating prominent display space for the relevant answer to the search query, the relevant answer being paired with a sponsor based, at least in part, upon relevance of the sponsor to the explicit and/or the implicit intent; and causing presentation of the relevant answer and indicia associated with the sponsor in association with one another in the prominent display space on a SERP.

In yet another embodiment, the present invention is directed to a system including an answer engine having one or more processors and one or more computer-readable storage media and a data store coupled with the answer engine. The answer engine is configured to receive a search query; extract answer content relevant to the received search query from one or more of a webpage associated with a sponsor and a webpage associated with a third party; allocate prominent display space for the relevant answer to the received search query, the relevant answer being paired with a sponsor; and cause presentation of the answer content and indicia associated with the sponsor in association with one another in the prominent display space on a SERP.

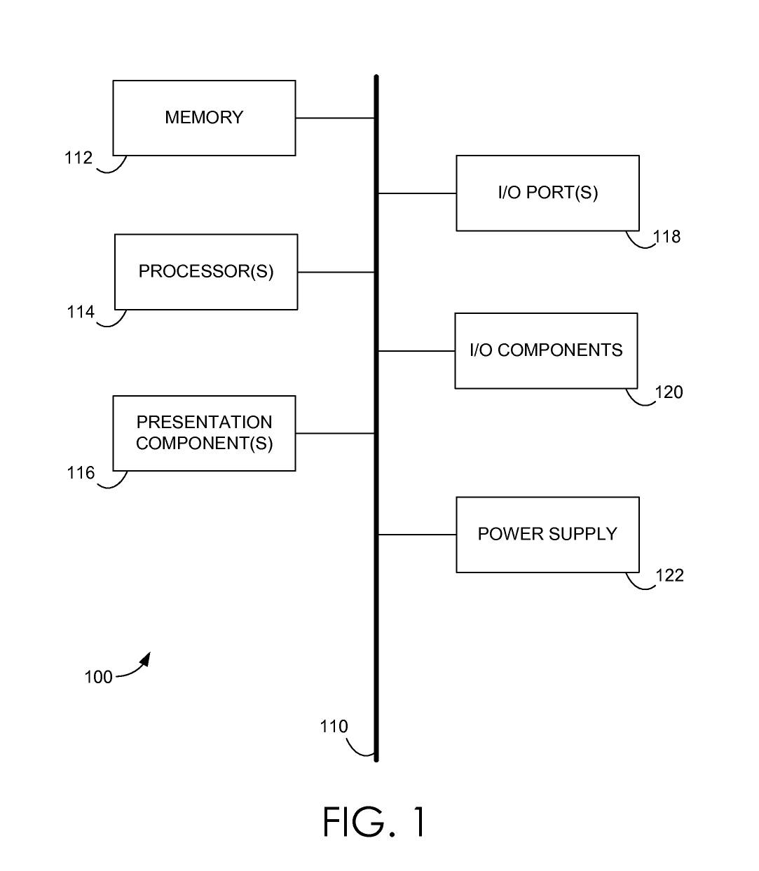

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search requests, words or symbols appearing in apps available for retrieval in response to input search requests, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

Furthermore, although the terms “search engine” and “answer engine” are used herein, it will be recognized that these terms may also encompass servers, web browsers, sets of one or more processes distributed on one or more computers, one or more stand-alone storage devices, sets of one or more other computing or storage devices, any combination of one or more of the above, and the like.

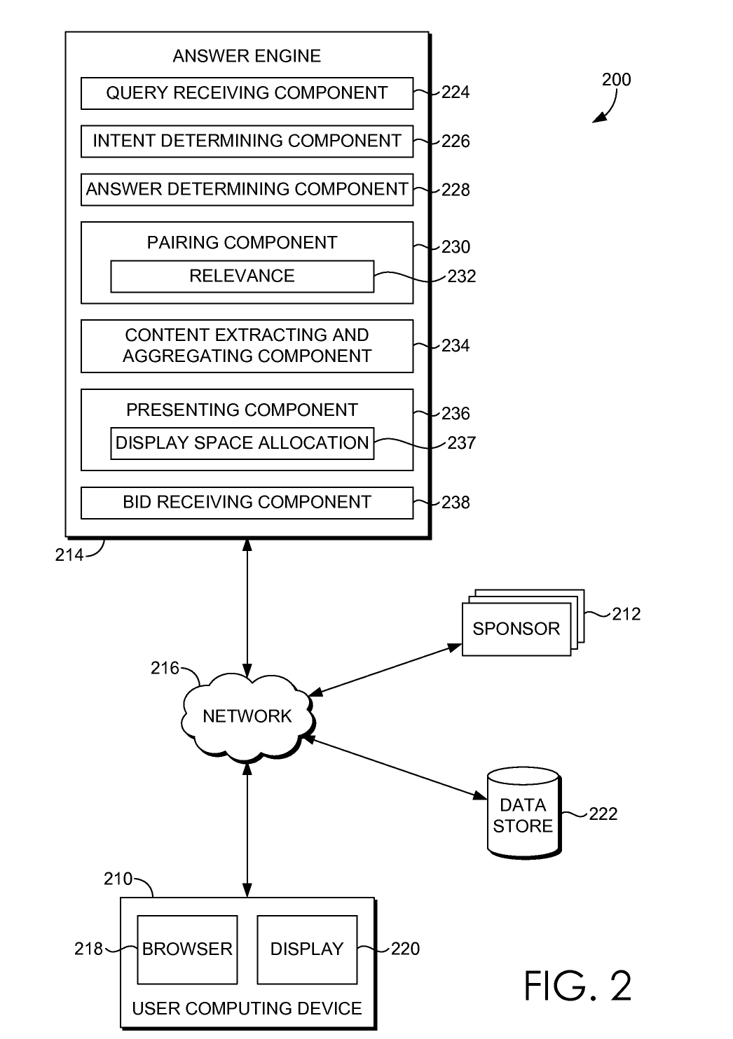

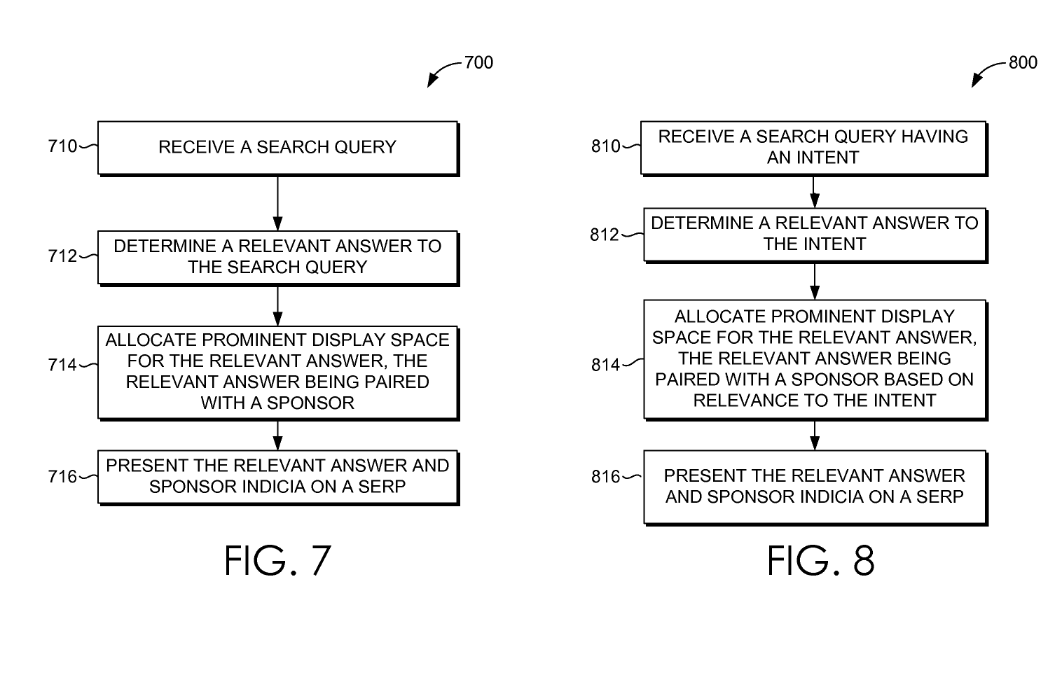

As previously set forth, embodiments of the present invention provide systems, methods, and computer-readable storage media for allocating prominent display space for relevant answers to search queries. With reference to FIG. 2, a block diagram is provided illustrating an exemplary computing system 200 in which embodiments of the present invention may be employed. Generally, the computing system 200 illustrates an environment in which a likely answer to a received search query and/or a likely intent associated with a received search query may be sponsored and prominently presented irrespective of whether the content of the answer is provided by or derived from the sponsor itself, in accordance with the methods, for instance, illustrated in FIGS. 7 and 8 (more fully described below). Among other components not shown, the computing system 200 generally includes a user computing device 210, one or more sponsor computing devices 212, and an answer engine 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices and/or answer engines may be employed in the computing system 200 within the scope of embodiments of the present invention. Each may comprise a single device/interface or multiple devices/interfaces cooperating in a distributed environment. For instance, the answer engine 214 may comprise multiple devices and/or modules arranged in a distributed environment that collectively provide the functionality of the answer engine 214 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the user computing device 210, the answer engine 214, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of answer engines, sponsor computing devices, and/or user computing devices. By way of example only, the answer engine 214 might be provided as a single computing device, a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown and/or described, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 includes a browser 218 and a display 220. The browser 218, among other things, is configured to render search engine home pages (or other online landing pages) and search engine results pages (SERPs), in association with the display 220 of the user computing device 210. The browser 218 further is configured to receive user input of requests for various web pages (including search engine home pages), receive user input search queries (generally input via an I/O component, such as a stylus or keypad, and/or via a user interface presented on the display 220 and permitting alpha-numeric and/or textual input into a designated search input region) and to receive content for presentation on the display 220, for instance, from the answer engine 214. It should be noted that the functionality described herein as being performed by the browser 218 may be performed by any other application, application software, user interface, or the like capable of rendering Web content. It should further be noted that embodiments of the present invention are equally applicable to mobile computing devices and devices accepting gesture, touch and/or voice input. Any and all such variations, and any combination thereof, are contemplated to be within the scope of embodiments of the present invention.

The sponsor computing device(s) 212 are configured to provide content and/or bidding or other purchasing information associated with one or more entities interested in sponsoring one or more answers to input search queries. In embodiments, the sponsor computing device(s) 212 may be associated with webpages having extractable content that may be utilized in constructing answers to input search queries and/or explicit or implicit intents associated with input search queries. The sponsor computing device(s) 212 may be accessed by the answer engine 214 via the network 216. Additionally, content associated with the sponsor computing device(s) 212, including webpage content, metadata, sponsorship conditions, and the like, may be stored in association with the data store 222, as more fully described below.

The answer engine 214 of the computing system 200 of FIG. 2 is configured to, among other things, receive search queries and provide relevant answers which may or may not be paired with a sponsor in response thereto. As illustrated, the answer engine 214 has access to a data store 222. The data store 222 is configured to store information related to at least one of one or more search queries, one or more sponsors, one or more advertisers, specific and/or aggregate user search behavior, user intent determining algorithms, user click data, and the like.

To the extent search behavior, click data, and the like that is specific to one or more users is stored in association with the data store 222, such user(s) may be permitted to consent to such data collection, in accordance with embodiments hereof. For instance, prior to collection of user-specific data, notice may be provided informing the user that such search data will be collected unless s/he opts out of such collection. Alternatively, the user may be asked to take affirmative action to consent to collection (i.e., to opt-in) before such data is collected. Any and all such variations, and any combination thereof, are contemplated to be within the scope of embodiments of the present invention.

In embodiments, the data store 222 is configured to be searchable for one or more of the items stored in association therewith. It will be understood and appreciated by those of ordinary skill in the art that the information stored in association with the data store may be configurable and may include any information relevant to, by way of example only, search queries, sponsors, advertisers, user behavior, user intent, and the like. The content and volume of such information are not intended to limit the scope of embodiments of the present invention in any way. Further, the data store 222 may be a single, independent component (as shown) or a plurality of storage devices, for instance a database cluster, portions of which may reside in association with the answer engine 214, the user computing device 210, another external computing device (not shown), and/or any combination thereof.

As illustrated, the answer engine 214 includes a query receiving component 224, an intent determining component 226, an answer determining component 228, a pairing component 230, a content extracting and aggregating component 234, a presenting component 236, and a bid receiving component 238. The query receiving component 224 is configured to receive a search query. In embodiments, the search query may be input by a user utilizing the user computing device 210, for instance, via an I/O component (not shown) such as a keypad or stylus and/or via a user interface presented on the display 220 of the user computing device 210 of FIG. 2 and permitting alpha-numeric and/or textual input into a designated search input region. Devices accepting gestures, touch and/or voice input may also be utilized in accordance with embodiments of the present invention.

In embodiments, a received search query may be associated with an explicit or implicit intent. That is, the query originator (e.g., query-inputting user) may have a specific intent on his or her mind upon input of the search query. Accordingly, the intent determining component 226 is configured to determine an explicit or implicit intent associated with a received search query—to determine what question is on the mind of the query originator upon inputting of the search query. In accordance with embodiments hereof, such explicit or implicit intent may be determined, at least in part, by reference to one or more of the search query content, search query history logs, search engine click metrics, user history (specific and/or aggregate), and or search query categories.

The answer determining component 228 is configured to determine a relevant answer to a received search query and/or an implicit or explicit intent associated with a received search query. In embodiments, such relevant answers may be determined utilizing algorithms known to those of ordinary skill in the art. The algorithms utilized to determine relevant answers to received search queries and/or associated explicit or implicit intents are not intended to limit the scope of embodiments of the present invention in any way.

The pairing component 230 is configured to pair a sponsor with the content of an answer intended for prominent presentation in association with a response to an input search query, such prominent presentation being more fully described below. The sponsor themselves may or may not have contributed to content included in the determined answer. Sponsors may be determined, by way of example only, based upon relevance of the sponsor to the input search query, an explicit or implicit intent associated with an input search query, and/or an answer determined to be relevant and responsive to an input search query. In this regard, the pairing component 230 includes a relevance component 232 that is configured to determine the relevance of one or more potential sponsors to an input query, an explicit or implicit intent, and/or a query answer.

In embodiments, sponsors may be determined, by way of example only, based upon bidding or other purchasing arrangements entered into by potential sponsors. In this regard, the bid receiving component 238 of the answer engine 214 is configured to receive and evaluate bids or other purchasing arrangements received from one or more potential sponsors.

A paired sponsor may or may not have contributed to content included in a determined answer. In this regard, the content extracting and aggregating component 234 is configured to extract content from webpages or other documents associated with one or more sponsors and/or content from webpages or other documents associated with third parties, that is, entities other than sponsors and/or query-originating users. In embodiments wherein the sponsor contributes to content to be included in the determined answer, at least a portion of the content may be extracted from a webpage associated with the sponsor. In embodiments wherein the sponsor either contributes or does not contribute to the content of the answer, at least a portion of the content may be extracted from one or more webpages associated with one or more third parties. Any and all such variations, or any combination thereof, are contemplated to be within the scope of embodiments of the present invention. Where a combination of content from a paired sponsor and a third party and/or multiple third parties is utilized to contribute to the content of the answer, at least a portion of the content from the multiple sources may be aggregated by the content extracting and aggregating component 234 of the answer engine 214.

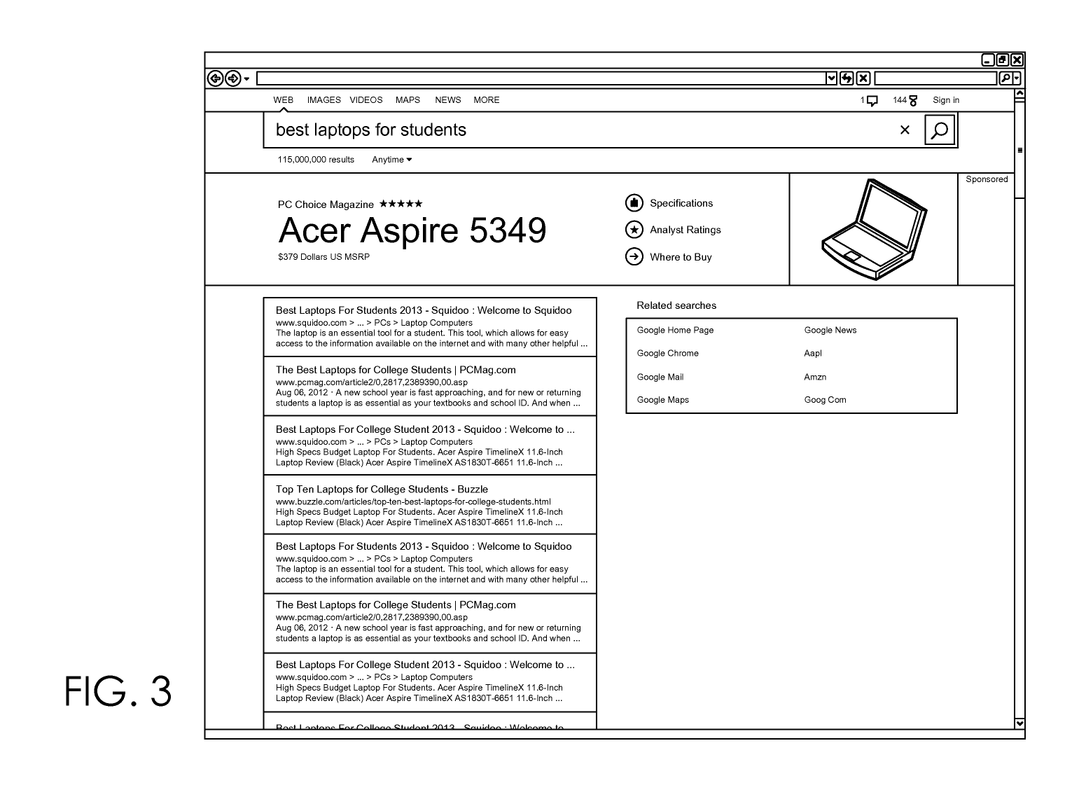

The presenting component 236 of the answer engine 214 is configured to cause to be presented, for instance, in a prominent display space in association with the display 220 of the user computing device 210, an answer to an input search query and, if desired, one or more traditionally-derived or traditionally-determined search results determined to be responsive to an input search query. In this regard, the display space allocation component 237 is configured to allocate prominent display space for relevant, sponsored answers to search queries. In embodiments, such prominent display space may be located at the top portion of a SERP (as shown in each of FIGS. 3-6, more fully described below) above a second portion of the SERP allocated for display of more traditional search results (or links thereto). It will be understood and appreciated by those of ordinary skill in the art, however, that any arrangement wherein the display space allocated for presentation of relevant, sponsored answers is easily noticeable and distinct from the presentation of traditional search results is contemplated to be within the scope of embodiments hereof. Such arrangements may include, without limitation, a location on one side of the SERP and/or arrangements incorporating differences in color, font, highlighting and the like with respect to the other SERP content.

Each of FIGS. 3-6 illustrates an exemplary screen shot of a SERP presented in accordance with an embodiment of the present invention, each SERP including a sponsored answer in association therewith. With reference to FIG. 3, a schematic diagram is shown of an exemplary screen shot illustrating presentation in a prominent display space of a sponsored answer to the search query “best laptops for students,” in accordance with an embodiment of the present invention. In the illustrated screen display, PC CHOICE MAGAZINE appears to have included an article dated Aug. 6, 2012 in its publication in which it listed the best laptops for college students. In response to the query “best laptops for students,” the system 200 of the present invention extracted content from the PC CHOICE MAGAZINE article and answered the user's question with the “Acer Aspire 5349.” The content of the answer (directed to the Acer Aspire 5349) is then sponsored, for instance, by an entity other than PC CHOICE MAGAZINE, for instance, the content of the answer may have been sponsored by ACER. A link to the PC CHOICE MAGAZINE article referencing the Acer Aspire 5349 as the best laptop for college students is included in a separate area of the SERP wherein traditionally-derived or traditionally-determined search results are listed.

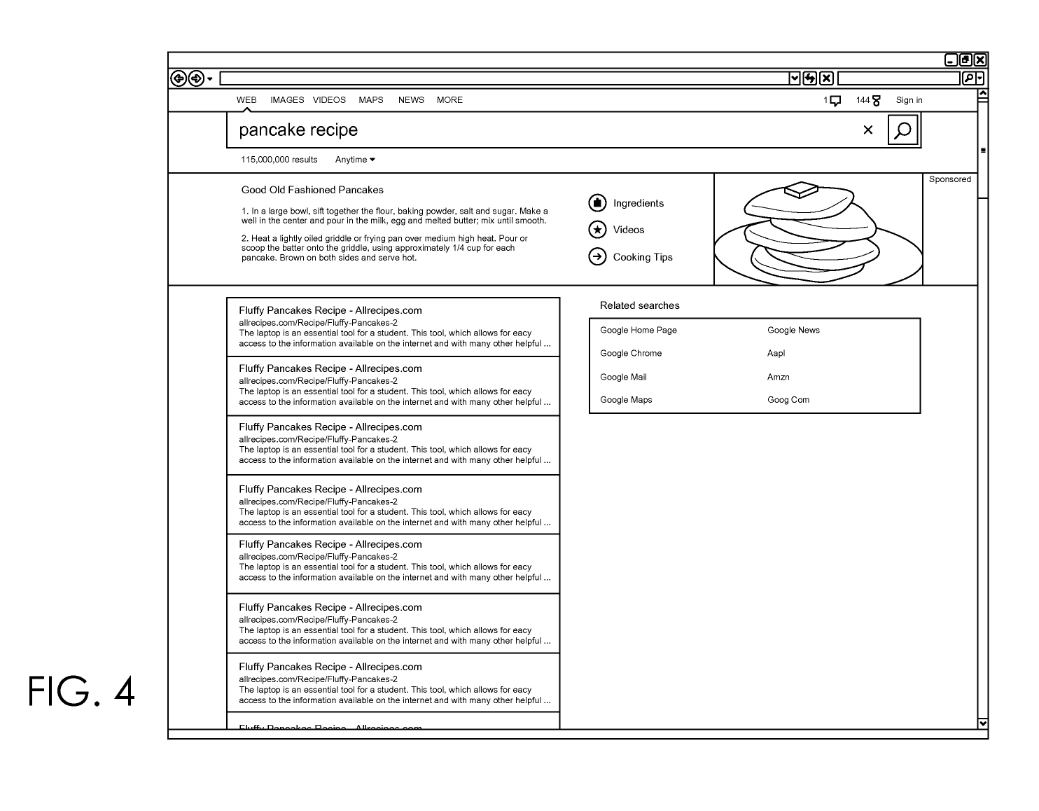

With reference to FIG. 4, a schematic diagram is illustrated of an exemplary screen shot showing presentation in a prominent display space of a sponsored answer to the search query “pancake recipe,” in accordance with an embodiment of the present invention. In the illustrated screen display, a specific pancake recipe has been extracted from an unidentified source and provided as an answer to the user's question with the “Good Old Fashioned Pancakes” recipe displayed in the top, prominent portion of the SERP. The content of the answer (directed to the “Good Old Fashioned Pancakes” recipe) is then sponsored, for instance, either by the entity from which the presented recipe was extracted or from another entity altogether (e.g., a third party entity). Several links to websites having pancake recipes associated therewith are included in a separate area of the SERP wherein traditionally-derived or traditionally-determined search results are listed.

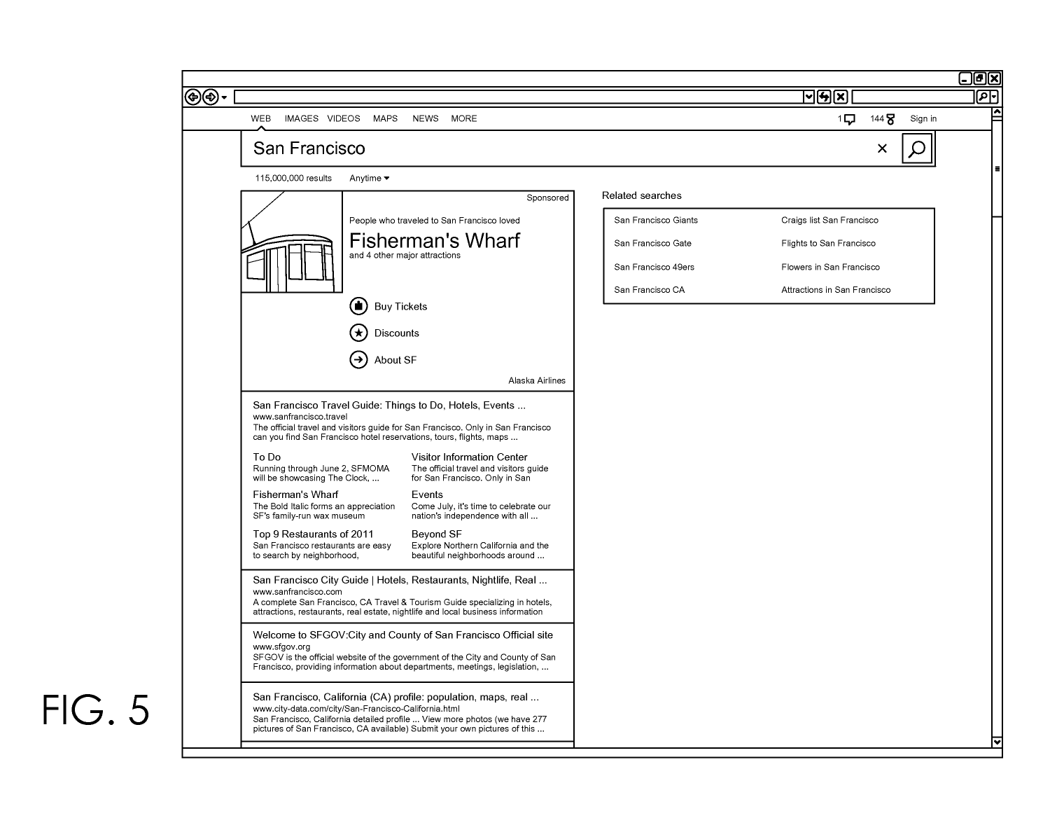

Referring to FIG. 5. a schematic diagram is shown of an exemplary screen shot illustrating presentation in a prominent display space of a sponsored answer to the search query “San Francisco,” in accordance with an embodiment of the present invention. In the illustrated screen display, an advertisement for “Fisherman's Wharf” is displayed in a prominent portion of the SERP. The content of the answer is then sponsored, in this case by ALASKA AIRLINES (a third party entity). Several links to websites having tourist information regarding San Francisco are included in a less prominent display space on the SERP wherein traditionally-derived or traditionally-determined search results are listed.

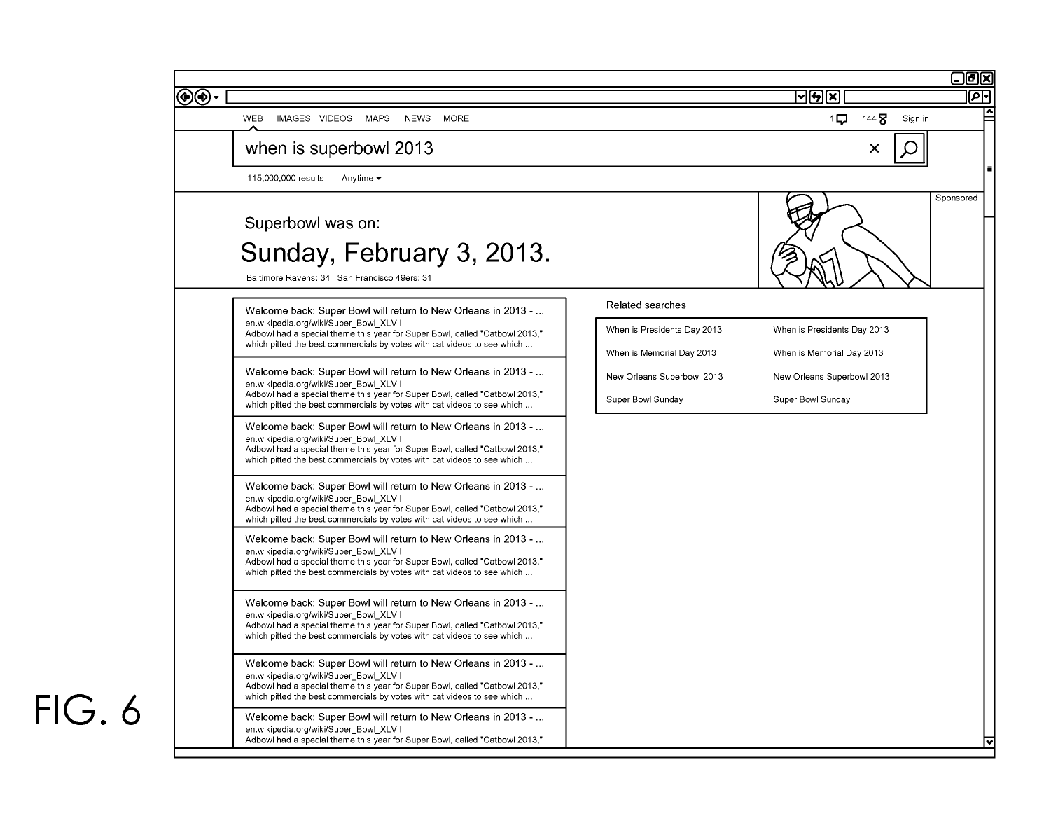

With reference to FIG. 6, a schematic diagram is illustrated of an exemplary screen shot showing presentation in a prominent display space of a sponsored answer to the search query “when is superbowl 2013,” in accordance with an embodiment of the present invention. In the illustrated screen display, an answer indicating the date of Super Bowl 2013 is provided in a prominent display space on the SERP. Though the date of the Super Bowl itself is not associated with any particular advertiser, the content of the answer, which was likely derived from one or more information rather than advertiser-related sources, may still be sponsored, for instance, by a sports equipment manufacturer, a television network, or the like. In this instance maybe even more than those illustrated in FIGS. 3-5, the sponsor is likely not a source of the content associated with the answer but rather has been selected as the sponsor of the answer via a bidding or other purchasing arrangement.

Turning now to FIG. 7, a flow diagram is illustrated showing an exemplary method 700 for allocating prominent display space for relevant answers to search queries, in accordance with an embodiment of the present invention. As indicated at block 710, a search query is received, for instance, by the query receiving component 224 of the answer engine 214 of FIG. 2. In embodiments, the search query may be input by a user utilizing the user computing device 210, for instance, via an I/O component (not shown) such as a keypad or stylus and/or via a user interface presented on the display 220 of the user computing device 210 of FIG. 2 and permitting alpha-numeric and/or textual input into a designated search input region. As previously set forth, devices accepting gesture, touch and/or voice input may also be utilized in accordance with embodiments of the present invention.

As indicated at block 712, a relevant answer to the received search query is determined, for instance, utilizing the answer determining component 228 of the answer engine 214 of FIG. 2. As previously set forth, the answer determining component 228 may determine a relevant answer to the received search query utilizing algorithms known to those of ordinary skill in the art. The algorithms utilized to determine a relevant answer to a received search query are not intended to limit the scope of embodiments of the present invention in any way.

As indicated at block 714, prominent display space for the relevant answer to the search query is allocated, the relevant answer being paired with a sponsor, e.g., utilizing the display space allocating component 237 and the pairing component 230 of the answer engine 214 of FIG. 2. An appropriate sponsor to pair with the relevant answer may be determined based upon, by way of example only, relevance of an advertiser selected for pairing to the query and/or an explicit or implicit intent of the query, or by virtue of a bidding or other purchasing program engaged in by the paired sponsor. Any and all such variations, and any combination thereof, are contemplated to be within the scope of embodiments of the present invention.

In accordance with embodiments hereof, a paired sponsor may or may not have contributed to content included in the determined answer. In embodiments wherein the sponsor contributed to content included in the determined answer, at least a portion of the content may have been extracted from a webpage associated with the sponsor. In embodiments wherein the sponsor either contributed or did not contribute to the content of the answer, at least a portion of the content may have been extracted from one or more webpages associated with third parties, that is, parties other than the user or the sponsor. Any and all such variations, or any combination thereof, are contemplated to be within the scope of embodiments of the present invention. Where a combination of content from a paired sponsor and a third party and/or multiple third parties is utilized to contribute to the content of the answer, at least a portion of the content from the multiple sources may be aggregated to determine the relevant answer.

Though not illustrated in FIG. 7, in embodiments, at least one of an explicit intent and an implicit intent associated with the received search query may be determined. In such embodiments, determining an answer to the received search query as indicated at block 712 may comprise determining an answer to the explicit or implicit intent associated therewith. Explicit or implicit intent may be determined, at least in part, by reference to one or more of search query history logs, search engine click metrics, user history (specific and/or aggregate), and or search query categories.

As indicated at block 714, the determined relevant answer and indicia associated with the paired sponsor (e.g, a logo or the like) are caused to be presented in the prominent display space in association with a SERP. In embodiments, the answer may be caused to be presented at a first position on the SERP while one or more links to traditionally-derived or traditionally-determined search results are presented at a second position on the SERP. In embodiments, the first position enjoys more prominent placement than the second position.

With reference now to FIG. 8, a flow diagram is illustrated showing another exemplary method 800 for allocating prominent display space for relevant answers to search queries, in accordance with an embodiment of the present invention. As indicated at block 810, a search query is received, for instance, by the query receiving component 224 of the answer engine 214 of FIG. 2, the search query having at least one of an explicit intent or an implicit intent associated therewith. In embodiments, the search query may be input by a user utilizing the user computing device 210, for instance, via an I/O component (not shown) such as a keypad or stylus and/or via a user interface presented on the display 220 of the user computing device 210 of FIG. 2 and permitting alpha-numeric and/or textual input into a designated search input region. As previously set forth, devices accepting gesture, touch and/or voice input may also be utilized in accordance with embodiments of the present invention. In accordance with embodiments hereof, implicit intent may be determined, at least in part, by reference to one or more of search query history logs, search engine click metrics, user history (specific and/or aggregate), and search query categories.

As indicated at block 812, a relevant answer to the explicit and/or the implicit intent is determined, for instance, utilizing the answer determining component 228 of the answer engine 214 of FIG. 2. As previously set forth, the answer determining component 228 may determine an answer to the received intent utilizing algorithms known to those of ordinary skill in the art. The algorithms utilized to determine an answer to an explicit or implicit intent are not intended to limit the scope of embodiments of the present invention in any way.

As indicated at block 814, prominent display space for the relevant answer is allocated, the relevant answer being paired with a sponsor, e.g., utilizing the display space allocation component 237 and the pairing component 230 of the answer engine 214 of FIG. 2, based, at least in part, upon relevance of the sponsor to the explicit and/or the implicit intent. Relevance algorithms are known to those of ordinary skill in the art and, accordingly, are not further described herein.

In accordance with embodiments hereof, a paired sponsor may or may not have contributed to content included in the determined relevant answer. In embodiments wherein the sponsor contributed to content included in the determined answer, at least a portion of the content may have been extracted from a webpage associated with the sponsor. In embodiments wherein the sponsor either contributed or did not contribute to the content of the answer, at least a portion of the content may have been extracted from one or more webpages associated with third parties, that is, a parties other than the user or the sponsor. Any and all such variations, and any combination thereof, are contemplated to be within the scope of embodiments of the present invention. Where a combination of content from a paired sponsor and a third party and/or multiple third parties is utilized to contribute to the content of the answer, at least a portion of the content from the multiple sources may be aggregated to determine the answer.

As indicated at block 816 the relevant answer and indicia associated with the paired sponsor (e.g, a logo or the like) are caused to be presented in the allocated prominent display space in association with a SERP. In embodiments, the answer may be caused to be presented at a first position on the SERP while one or more links to traditionally-derived or traditionally-determined search results are caused to be presented at a second position on the SERP. In embodiments, the first position enjoys more prominent placement than the second position.

As can be understood, embodiments of the present invention provide systems, methods, and computer-readable storage media for, among other things, allocating prominent display space for relevant answers to search queries. Upon receipt of a search query (e.g., via a search engine or the like), an intent associated with the search query is determined. That is, it is determined what question the search query states or implies is on the mind of the search query originator. Once the intent is determined, an answer to the search query is determined, for instance, by reference to one or more of search query history logs, search engine click metrics, user history (specific and/or aggregate), and search query categories. The answer is then paired with a sponsor (for instance, an advertiser) and prominent display space for the relevant answer is allocated. The relevant answer and indicia associated with the sponsor (e.g., a logo) are caused to be presented in association with one another in the prominent display space on a search engine results page.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 700 of FIGS. 7 and 800 of FIG. 8 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for allocating prominent display space for relevant answers to search queries:
receiving a search query;
determining a relevant answer to the received search query;
allocating prominent display space for the relevant answer to the search query, the relevant answer being paired with a sponsor;
and
causing presentation of the answer and indicia associated with the sponsor in association with one another in the prominent display space on a Search Engine Results Page (SERP).

2. The one or more computer-readable storage media of claim 1, wherein the method further comprises determining at least one of an explicit intent or an implicit intent associated with the received search query, and wherein determining a relevant answer to the received search query comprises determining a relevant answer to the explicit or implicit intent associated with the received search query.

3. The one or more computer-readable storage media of claim 2, wherein the explicit or implicit intent is determined, at least in part, by reference to one or more of search query history logs, search engine click metrics, user history, and search query categories.

4. The one or more computer-readable storage media of claim 1, wherein the relevant answer includes content associated therewith, and wherein the method further comprises:
extracting at least a portion of the content from a webpage associated with the sponsor.

5. The one or more computer-readable storage media of claim 1, wherein the relevant answer includes content associated therewith, and wherein the method further comprises:
extracting at least a portion of the content from a third party.

6. The one or more computer-readable storage media of claim 1, wherein the relevant answer includes content associated therewith, and wherein the method further comprises:
extracting the content from multiple sources; and
aggregating at least a portion of the content from the multiple sources to determine the relevant answer.

7. The one or more computer-readable storage media of claim 1, wherein the relevant answer is paired with the sponsor, at least in part, based upon relevance of the sponsor to the search query.

8. The one or more computer-readable storage media of claim 2, wherein the relevant answer is paired with the sponsor, at least in part, based upon relevance of the sponsor to the explicit or implicit intent associated with the received search query.

9. The one or more computer-readable storage media of claim 1, wherein the relevant answer is caused to be presented at a first position on the SERP coinciding with the prominent display space, and wherein one or more links to search results are caused to be presented at a second position on the SERP.

10. A method being performed by one or more computing devices including at least one processor, the method for allocating prominent display space for relevant answers to search queries, the method comprising:
receiving a search query having at least one of an explicit intent or an implicit intent;
determining a relevant answer to the explicit and/or the implicit intent;
allocating prominent display space for the relevant answer to the search query, the relevant answer being paired with a sponsor based, at least in part, upon relevance of the sponsor to the explicit and/or the implicit intent; and
causing presentation of the relevant answer and indicia associated with the sponsor in association with one another in the prominent display space on a Search Engine Results Page (SERP).

11. The method of claim 10, further comprising determining the explicit or implicit intent, at least in part, by reference to one or more of search query history logs, search engine click metrics, user history, and search query categories.

12. The method of claim 10, wherein the relevant answer includes content associated therewith, and wherein the method further comprises:
extracting at least a portion of the content from a webpage associated with the sponsor.

13. The method of claim 10, wherein the relevant answer includes content associated therewith, and wherein the method further comprises:
extracting at least a portion of the content from a third party.

14. The method of claim 10, wherein the relevant answer includes content associated therewith, and wherein the method further comprises:
extracting the content from multiple sources; and
aggregating at least a portion of the content from the multiple sources to determine the relevant answer.

15. The method of claim 10, wherein the relevant answer is caused to be presented at a first position on the SERP coinciding with the prominent display space, and wherein one or more links to search results are caused to be presented at a second position on the SERP.

16. The method of claim 15, wherein the first position on the SERP is more prominent than the second position on the SERP.

17. A system comprising:
an answer engine having one or more processors and one or more computer-readable storage media; and
a data store coupled with the answer engine,
wherein the answer engine:
receives a search query;
extracts answer content relevant to the received search query from one or more of a webpage associated with a sponsor and a webpage associated with a third party;
allocating prominent display space for the relevant answer to the received search query, the relevant answer being paired with the sponsor; and
causes presentation of the answer content and indicia associated with the sponsor in association with one another in the prominent display space on a Search Engine Results Page (SERP).

18. The system of claim 17, wherein the answer engine further determines at least one of an explicit intent or an implicit intent associated with the received search query, and extracts answer content relevant to the received search query based, at least in part, upon the explicit or implicit intent.

19. The system of claim 18, wherein the explicit or implicit intent is determined, at least in part, by reference to one or more of search query history logs, search engine click metrics, user history, and search query categories.

20. The system of claim 17, wherein the answer content is caused to be presented at a first position on the SERP coinciding with the prominent display space, and wherein one or more links to search results are caused to be presented at a second position on the SERP.
